(19) United States
(12) Patent Application Publication
(10) Pub. No.: US 2009/0047906 A1
(43) Pub. Date: Feb. 19, 2009

(54) METHOD AND SYSTEM FOR MICROWAVE DETECTION

(75) Inventor: Guoqing Li, Portland, OR (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/837,996

(22) Filed: Aug. 13, 2007

(51) Int. Cl. H04B 1/00

(52) U.S. Cl. 455/63.1

(57) ABSTRACT

Disclosed are a method and system for triggering a wireless device to perform sensing of wireless spectrum to detect microwave signal interference in a wireless medium. The wireless device transmits one or more packets and checks the status of transmission for each packet. Based on the status of transmission of the packet, counters are updated. Symbols are generated to correspond to an ON/OFF pattern of an interference signal, when the counters exceed a pre-defined threshold value. A plurality of symbols corresponding to transmission of one or more packets forms a sequence. The sequence is compared with a pre-defined pattern. The occurrence of a match between the sequence and the pre-defined pattern signifies presence of a periodic interference signal. Sensing of wireless spectrum is then triggered to detect microwave signal interference.

### FIELD OF THE DISCLOSURE

The present disclosure generally relates to packet transmissions in a wireless medium, more particularly, to a method and a system for triggering a wireless device to perform sensing of a wireless spectrum for detecting interference in packet transmissions in the wireless medium.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIGS. 1A and 1B illustrate throughput performance of an 802.11 link without interference from a microwave oven signal and with interference from the microwave oven signal, respectively;

FIG. 2 illustrates a variation in power of a microwave oven signal with respect to variation in distance from a source of the microwave oven signal;

FIG. 3 illustrates a periodic microwave oven signal plotted with respect to time;

FIG. 4 illustrates an environment in which various embodiments of the present disclosure may be practiced;

FIG. 5 is a block diagram of a wireless device, in accordance with an embodiment of the present disclosure;

FIG. 6 is a flow diagram illustrating a method for triggering a wireless device, in accordance with an embodiment of the present disclosure;

FIG. 7 is a flow diagram illustrating an exemplary method for triggering a wireless device, in accordance with an embodiment of the present disclosure;

FIG. 8 is a flow diagram illustrating another exemplary method for triggering a wireless device, in accordance with an embodiment of the present disclosure; and

FIGS. 9A and 9B illustrate change in the contention window size and retransmission counter with respect to microwave oven signal variations respectively, in accordance with an embodiment of the present disclosure.

Like reference numerals refer to like parts throughout the description of several views of the drawings.

### DETAILED DESCRIPTION OF THE DISCLOSURE

For a thorough understanding of the present disclosure, refer to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present disclosure provides a method and system for triggering a wireless device to perform sensing of a wireless spectrum to detect microwave signal interference in a wireless medium. The wireless device transmits one or more packets and checks the status of transmission for each packet. Based on the status of transmission of the packet, counters are updated. Symbols are generated to correspond to an ON/OFF pattern of an interference signal when the counters exceed a pre-defined threshold value. A plurality of such symbols corresponding to transmission of one or more packets forms a sequence. The sequence is compared with a pre-defined pattern. The occurrence of a match between the sequence and the pre-defined pattern signifies presence of a periodic interference signal. Sensing of a wireless spectrum is then triggered to detect microwave signal interference.

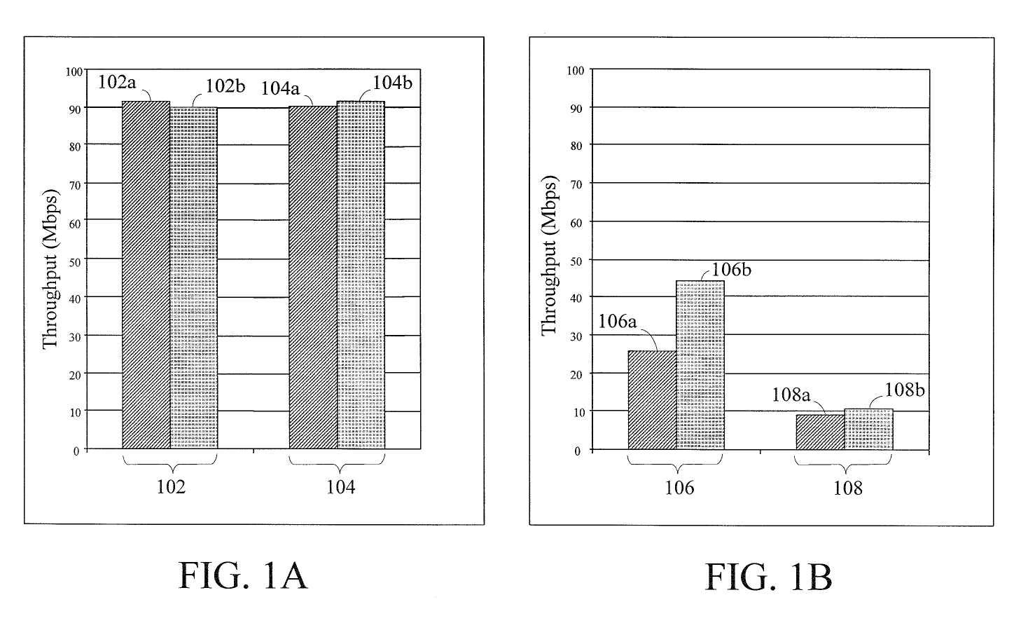

FIG. 1A illustrates throughput performance of an 802.11 link without interference from a microwave oven signal. FIG. 1B illustrates throughput performance of an 802.11 link with interference from a microwave oven signal. The throughput performance of the 802.11 link may be defined as the speed of transmission of packets over the wireless channel and is measured in Megabits per second (Mbps) (shown on the Y-axes of FIGS. 1A and 1B). FIG. 1A is a plot of throughput performance of the 802.11 link measured in an isolated house without interference from the microwave oven signal. The plot shown in FIG. 1A depicts line of sight (LOS) measurements 102 and non line of sight (NLOS) measurements 104 of the throughput of the 802.11 link. The LOS measurements 102 comprises LOS measurement 102a and LOS measurement 102b representing LOS measurement of the throughput of the 802.11 link performed using an omnidirectional antenna and a directional antenna, respectively. The NLOS measurements 104 comprise NLOS measurement 104a and NLOS measurement 104b, which measurements of the throughput of the 802.11 link are performed using the omnidirectional antenna and the directional antenna, respectively.

FIG. 1B is a plot of throughput performance of the 802.11 link measured in the isolated house in the presence of interference from the microwave oven signal. The plot in FIG. 1B depicts line of sight (LOS) measurements 106 and non line of sight (NLOS) measurements 108 of the throughput of the 802.11 link with microwave oven signal interference in the isolated house. LOS measurement 106a and LOS measurement 106b represent LOS measurement of the throughput of the 802.11 link performed using an omnidirectional antenna and a directional antenna, respectively. NLOS measurements 108a and 108b represent NLOS measurement of the throughput of the 802.11 link performed using an omnidirectional antenna and a directional antenna respectively. It may be observed from FIGS. 1A and 1B that the microwave oven signal degrades the throughput performance of the 802.11 link by 60 percent to 70 percent.

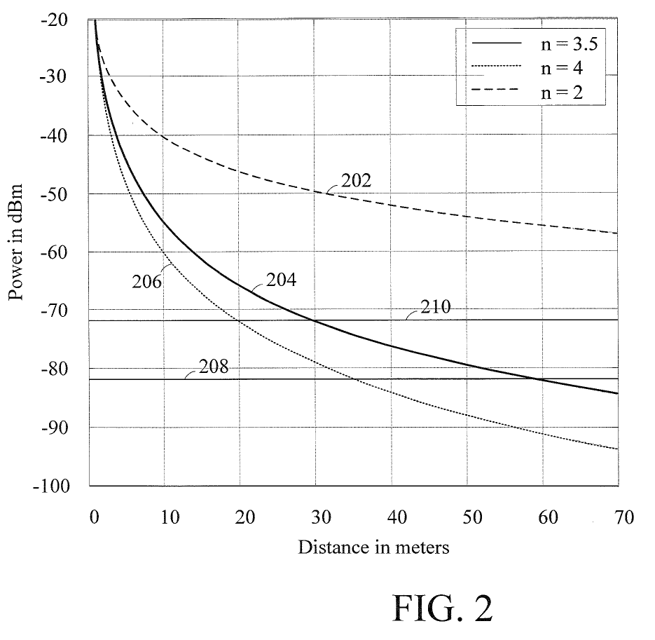

FIG. 2 illustrates a variation in power of a microwave oven signal with respect to variation in distance from a source of the microwave oven signal. In FIG. 2, the variation in power (measured in decibels referenced to milliwatt) of the microwave oven signal is plotted with respect to distance (measured in meters) for multiple values of n which is the path loss exponent of the environment. The plots for values n=2, n=3.5 and n=4 are depicted as plot 202, plot 204 and plot 206 respectively. It may be observed from the plots that the microwave oven signal degrades as the distance increases. The microwave oven signal carries substantial power to cause interference in multiple homes, as can be seen from the distance (X-axis) over which the microwave oven signal degrades in FIG. 2.

FIG. 2 further depicts a clear channel assessment threshold 208 for sensing the microwave oven signal. A power level 210 depicts receiver sensitivity at 54 Megabits per second (Mbps) for reference in FIG. 2. The power level 210 is the amount of power that a transceiver in a wireless device must receive to achieve desired signal-to-noise ratio. The power level of 208 is the Clear-channel-assessment (CCA) threshold that a receiver considers the wireless channel as busy if the received power is over this threshold.

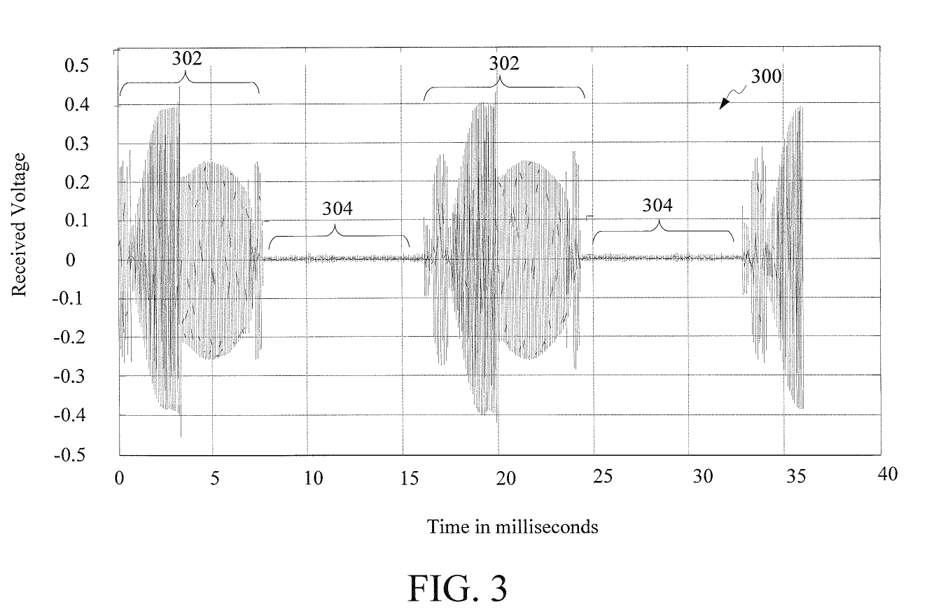

FIG. 3 illustrates a periodic microwave oven signal 300 plotted with respect to time (measured in milliseconds). The periodic microwave oven signal 300 comprises a series of ON periods such as an ON period 302 and OFF periods such as an OFF period 304 occurring alternatively. The ON period 302 is characterized with an increase in the received voltage and the OFF period 304 is characterized with minimum received voltage as can be seen in FIG. 3. It may be observed from the plot of the microwave oven signal 300 that the ON period 302 and the OFF period 304 occur in a periodic manner. Typically, the ON period 302 and the OFF period 304 lasts for a duration of 6 milliseconds to 16 milliseconds depending on the frequency of a microwave oven signal 300. Typical frequencies used in microwaves are 50 Hertz and 60 Hertz.

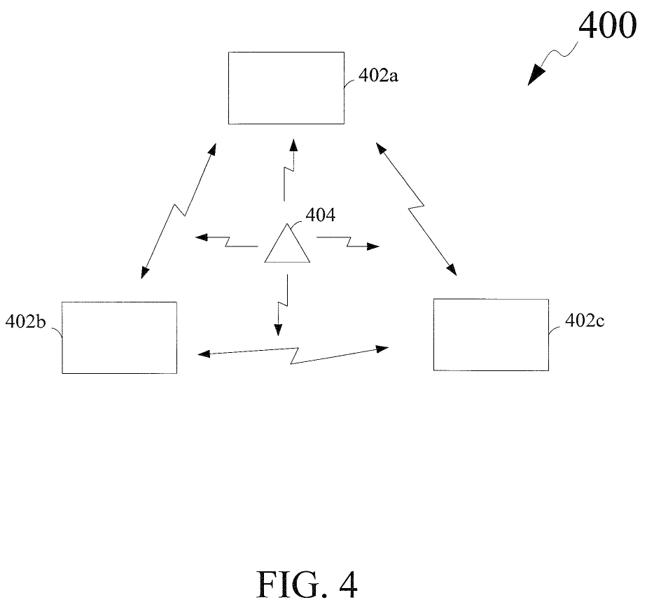

FIG. 4 illustrates an environment 400 in which various embodiments of the present disclosure may be practiced. The environment 400 comprises one or more wireless devices such as a wireless device 402a, a wireless device 402b and a wireless device 402c, and, an interference source such as interference source 404. The wireless devices 402a, 402b and 402c will hereinafter be collectively referred to as wireless devices 402. The wireless devices 402 may be in operative communication with each other or with an access point or a wireless router (not shown in FIG. 4). The wireless devices 402 communicate with each other by transmitting/receiving data in form of data packets (hereinafter referred to as packets). The packets are sent over a wireless medium such as air at frequencies typically used for wireless communications. Typical frequency bands used for wireless communications are unlicensed Industry, Scientific and Medical (ISM) bands such as 2.4 Gigahertz (GHz) and 5 GHz frequency bands. Examples of environment 400 may include a house, a neighborhood, an office setting and the like. Examples of wireless devices 402 may include but are not limited to personal computers such as laptops, and personal digital assistants (PDAs). Examples of the interference source 404 may be a microwave oven, a cordless phone, a Bluetooth device and the like.

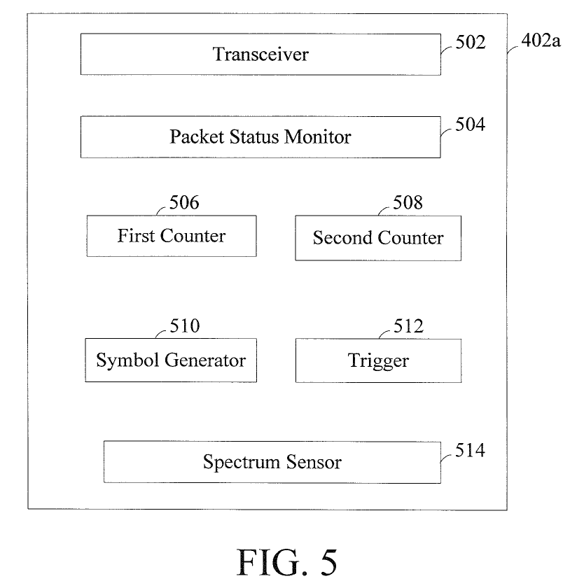

The wireless devices 402 typically comply with wireless standards such as the 802.11 specifications for wireless communications. The 802.11 compliant wireless devices 402 typically use protocols such as Carrier Sense Multiple Access (CSMA) for transmission purposes. To prevent collisions, the wireless devices 402 may obey protocols such as CSMA/CA (Carrier Sense Multiple Access with Collision Avoidance) wherein wireless device such as wireless device 402a informs other wireless devices 402 of intent to transmit. The interference source 404 may operate at an operating frequency defined for that particular type of device. For instance, a microwave oven may operate in the unlicensed Industry, Scientific and Medical (ISM) band, thereby causing interference to packet transmissions from the wireless devices 402. The wireless device such as wireless device 402a is explained in detail in conjunction with FIG. 5.

FIG. 5 is a block diagram of a wireless device, such as the wireless device 402a, in accordance with an embodiment of the present disclosure. The wireless device 402a comprises a transceiver 502, a packet status monitor 504, a first counter 506, a second counter 508, a symbol generator 510, a trigger 512 and a spectrum sensor 514. The wireless device 402a communicates with other wireless devices 402 using the transceiver 502. The transceiver 502 is capable of transmitting and receiving one or more packets. Examples of transceiver 502 may include wireless transceivers such as a radio frequency (RF) modem and the like. The packet status monitor 504 checks status of the transmission of the transmitted packet for one of a first status and a second status. The first status corresponds to retransmission of the packet signifying failure of transmission of the packet to a desired destination. The second status corresponds to successful transmission of the packet to the desired destination. The packet transmitted by the wireless device 402a over the wireless medium to the desired destination may be lost or information contained in the packet may get garbled on account of interference caused by a signal from a microwave device or on account of collision with a packet from another wireless device such as the wireless device 402b. In such instances, the packet may be retransmitted by the wireless device 402a to the desired destination. Successful transmission of the packet is achieved when the desired destination receives the packet without error. The desired destination may be a wireless device such as wireless device 402b, an access point, a wireless router and the like.

The first counter 506 maintains count of the number of retransmissions of the packet. The second counter 508 maintains the count of the number of times the packets are transmitted successfully. The count of the first counter 506 and the count of the second counter 508 are updated based on the status of the transmission of the packet. In one embodiment of the present disclosure, the count of the first counter 506 may be incremented by a fixed value and the count of the second counter may be set to zero when the status of the transmission of the packet is the first status. In one embodiment of the present disclosure, the count of the first counter is set to zero and the count of the second counter incremented by a fixed value when the status of transmission of the packet is the second status. It will be evident to those skilled in the art that the count of the first counter, the count of the second counter, the fixed value for incrementing the count may be chosen to be any pre-defined numerical values.

The symbol generator 510 generates a symbol by comparing the count of the first counter 506 with a first threshold value and the count of the second counter 508 with a second threshold value. The symbol provides indication of the presence of an interference signal. For instance, the count of the first counter 506 (corresponding to the number of times the packet is retransmitted) exceeding the first threshold value may provide indication of an ON period of the interference signal. The symbol generator 510 may generate a symbol corresponding to logic value 1 indicating the ON period of the interference signal. Similarly, the count of the second counter 508 (corresponding to the number of times packets are transmitted successfully) exceeding the second threshold value may provide indication of an OFF period of the interference signal. The symbol generator 510 may generate a symbol corresponding to the logic value 0 indicating an OFF period of the interference signal. It will be evident to those skilled in the art that the symbol generator 510 may generate any symbol to indicate the ON period and the OFF period of the interference signal. The first threshold value and the second threshold value may be chosen to be a sufficiently large number to provide accurate indication of the presence of the interference signal.

The trigger 512 continuously monitors a sequence of such symbols corresponding to transmission of the one or more packets for a match with a pre-defined pattern. The sequence may be defined to have fixed number of symbols. For instance, the sequence may be defined to comprise six consecutive symbols. The trigger 512 may then monitor six consecutive symbols for occurrence of the match with the pre-defined pattern. In one embodiment of the present disclosure, the sequence may be any dynamically chosen number of symbols.

On occurrence of a match between the sequence and the pre-defined pattern, the trigger 512 triggers the spectrum sensor 514 to perform sensing of the wireless spectrum to detect interference in wireless medium. The spectrum sensor senses the wireless medium to detect interference in the wireless medium. Sensing the wireless medium comprises scanning all the frequencies for wireless transmission and performing interference characterization to determine the type and nature of interference. An example of the type and nature of interference may be an interference encountered from a microwave signal with periodic ON/OFF patterns. Once the nature and type of interference is determined during interference characterization, a Media Access Control (MAC) layer in the wireless device (not shown in the FIG. 5) may then adapt the packet transmission to prevent collision of packets due to the interference in the wireless medium.

In one embodiment of the present disclosure, the packet status monitor 504 monitors the count of a retry counter to check the status of transmission of the packet. A non-zero value of the count of the retry counter indicates retransmission of the packet while a zero value of the count of the retry counter indicates successful transmission of the packet. Thus, the non-zero value of the count of the retry counter corresponds to the first status and the zero value of the count of the retry counter corresponds to the second status for the transmission of the packet. It will be evident to those skilled in the art that the different numeric values may be used for the count of the retry counter to indicate the first status and the second status. The retry counter may operatively communicate with the transceiver 502 to check the status of the packet. The desired destination may send an acknowledgement upon receipt of a packet. The acknowledgement may be received by the wireless device 402a at the transceiver 502. The retry counter may be set to the non-zero value when no acknowledgement is received at the transceiver 502. The retry counter may be set to zero value on receipt of the acknowledgement at the transceiver 502. It will be evident to the person skilled in the art that the retry counter may detect failure of transmission without the need to operatively communicate with the transceiver 502 to indicate the status of transmission of the packet.

In another embodiment of the present disclosure, the packet status monitor 504 monitors current contention window size for transmission of the packet to check the status of packet transmission. The packet status monitor 504 may compare the current contention window size with a pre-defined minimum contention window size. The contention window size typically increases as the number of retransmissions of the packet increases. The current contention window size exceeding the pre-defined minimum contention window size indicates retransmission of the packet. The pre-defined minimum contention window size exceeding the current contention window size indicates successful transmission of the packet. Thus, the current contention window size exceeding the pre-defined minimum contention window size corresponds to the first status and the pre-defined minimum contention window size equaling the current contention window size corresponds to the second status for the transmission of the packet. It will be evident to those skilled in the art that the contention window size is reset to its minimum size on the successful transmission of the packet. Furthermore, the pre-defined minimum contention window size may be suitably chosen to be a fixed number of time slots or dynamically changed to adjust to congestion level in the wireless medium.

It will be evident to a person skilled in the art that the wireless device 402a may include the requisite electrical circuits and connections to connect the transceiver 502, the packet status monitor 504, the first counter 506, the second counter 508, the symbol generator 510, the trigger 512 and the spectrum sensor 514. It will also be obvious to the person skilled in the art that the wireless device 402a may further include a microcontroller for managing operations of the wireless device 402a, a memory module for storing instructions for operating the wireless device 402a and a storage module for storing packets in the wireless device 402a.

Additionally, constituents of the wireless device 402a such as the transceiver 502, the packet status monitor 504, the first counter 506, the second counter 508, the symbol generator 510, the trigger 512 and the spectrum sensor 514 may be implemented as a hardware module, software module, firmware or any combination thereof.

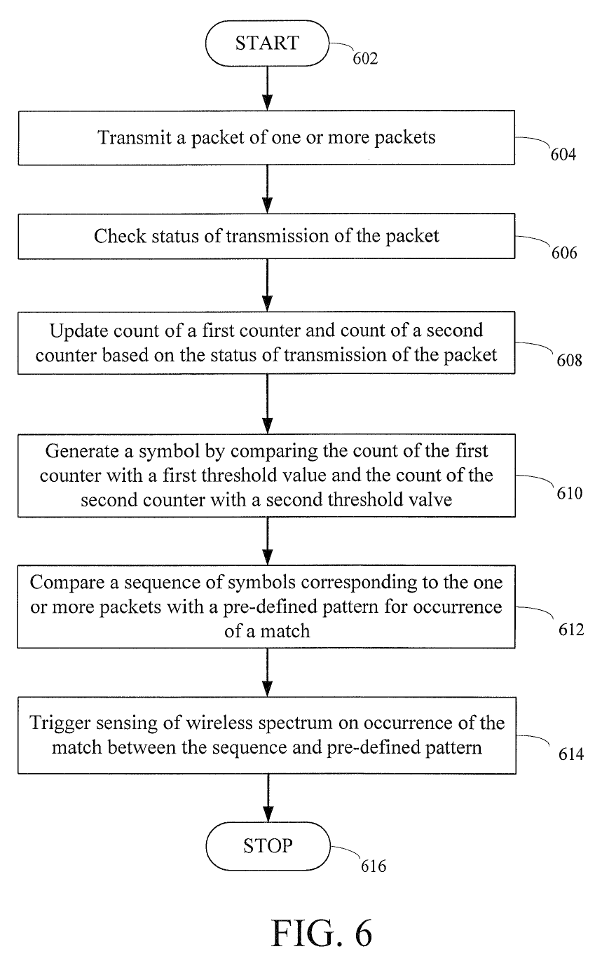

FIG. 6 is a flow diagram illustrating a method for triggering a wireless device, in accordance with an embodiment of the present disclosure. The method initiates at 602 on the reception of a packet at a transceiver of a wireless device, such as the wireless device 402a, to be sent over a wireless medium to a desired destination. At 604, the packet is transmitted over the wireless medium. At 606, the status of transmission of the packet is checked for one of a first status and a second status. The first status corresponds to retransmission of the packet and the second status corresponds to successful transmission of the packet. At 608, count of a first counter and a count of second counter are updated based on the status of the transmission of the packet. At 610, a symbol is generated based on comparing the count of the first counter with a first threshold value and the count of the second counter with a second threshold value. At 612, a sequence of symbols corresponding to transmission of the one or more packets is compared with a pre-defined pattern. At 614, the wireless device is triggered to perform sensing of the wireless spectrum on occurrence of a match between the sequence and the pre-defined pattern. Sensing of the wireless spectrum is performed for interference characterization. At 616, the method ends with a MAC layer in the wireless device adapting to an interference pattern to prevent failure of transmission due to presence of interference.

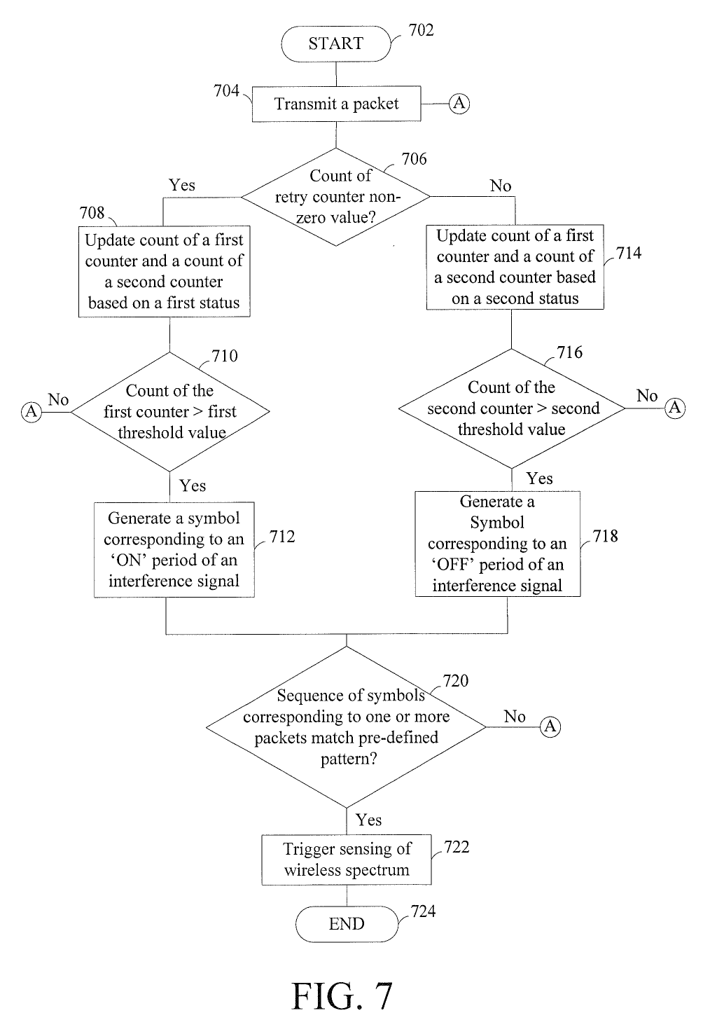

FIG. 7 is a flow diagram illustrating an exemplary method for triggering a wireless device, in accordance with an embodiment of the present disclosure. The method initiates at 702 on the reception of a packet at a transceiver of a wireless device, such as the wireless device 402a, to be sent over a wireless medium to a desired destination. At 704, the packet is transmitted over the wireless medium. At 706, the status of transmission of the packet is checked for one of a first status and a second status by checking the count of a retry counter. The first status corresponds to retransmission of the packet and the second status corresponds to successful transmission of the packet. If the count of the retry counter is a non-zero value then 708 is performed. The non-zero value of the count of the retry counter indicates failure of the transmission of the packet (corresponding to the first status of the transmission of the packet). A zero value of the count of the retry counter indicates successful transmission of the packet (corresponding to the second status of the transmission of the packet). At 708, a count of a first counter and a count of a second counter are updated based on the first status. Do you need to explain what (A) is in the diagram? (A) is basically indicating no specific actions needed for counters and will go to 806 to re-check 706, right?

At 710, the count of the first counter is compared with a first threshold value. If the count of the first counter exceeds the first threshold value then 712 is performed. At 712, a symbol corresponding to an ON period of an interference signal is generated. If the count of the first counter is lower than the first threshold value then 704 is performed and the packet is retransmitted and similar procedure from 706 to 710 is followed until the count of the retry counter assumes the zero value, signifying successful transmission of the packet. When the count of the retry counter has a zero value, 714 is performed. At 714, the count of the first counter and the count of the second counter are updated based on the second status. At 716, the count of the second counter is compared with a second threshold value. If the count of the second counter exceeds the second threshold value then 718 is performed. If the count of the second counter is lower than the second threshold value then 704 is performed and a subsequent packet of a one or more packets is transmitted. At 718, a symbol corresponding to an OFF period of the interference signal is generated.

Transmission of the one or more packets results in generation of a sequence of symbols. At 720, a sequence comprising a pre-defined length number of symbols is compared with a pre-defined pattern for occurrence of a match. If the sequence matches the pre-defined pattern, then 722 is performed. At 722, sensing of the wireless spectrum is triggered. If the sequence does not match the pre-defined pattern then 704 is performed for a new packet or, in the case of first status, for a retransmitted packet. The method ends at 724. At 724, a MAC layer in the wireless device adapts the transmission of the packets to the interference detected by sensing the wireless spectrum.

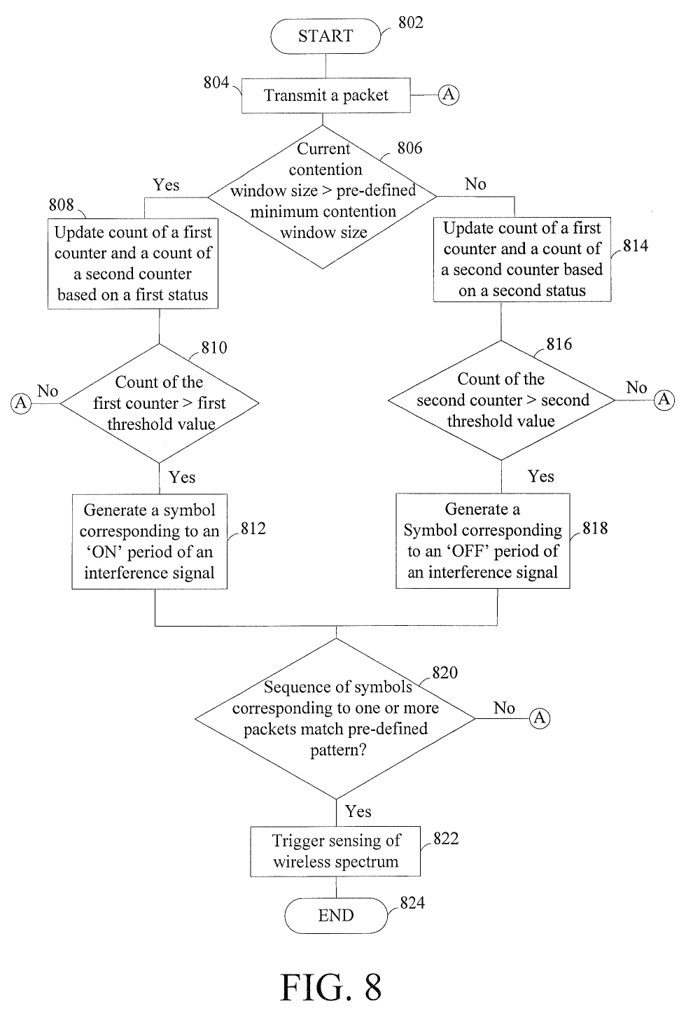

FIG. 8 is a flow diagram illustrating another exemplary method for triggering a wireless device, in accordance with an embodiment of the present disclosure. The method initiates at 802, on the reception of a packet at a transceiver of a wireless device, such as the wireless device 402a, to be sent over a wireless medium to a desired destination. At 804, the packet is transmitted over the wireless medium. At 806, the status of the transmission of the packet is checked for one of a first status and a second status by checking a current contention window size for transmission of the packet with a pre-defined minimum contention window size. The first status corresponds to retransmission of the packet and the second status corresponds to successful transmission of the packet. If the current contention window size exceeds the pre-defined minimum contention window size, then 808 is performed. The current contention window size exceeding the pre-defined minimum contention window size indicates failure of the transmission of the packet (corresponding to the first status of the transmission of the packet). The pre-defined minimum contention window size exceeding the current contention window size indicates successful transmission of the packet (corresponding to the second status of the transmission of the packet).

At 808, a count of a first counter and a count of a second counter are updated based on the first status. At 810, the count of the first counter is compared with a first threshold value. If the count of the first counter exceeds the first threshold value then 812 is performed. At 812, a symbol corresponding to an ON period of an interference signal is generated. If the count of the first counter is lower than the first threshold value then 804 is performed and the packet is retransmitted and a similar procedure from 806 to 810 is followed until the pre-defined minimum contention window size exceeds the current contention window size signifying successful transmission of the packet. When the pre-defined minimum contention window size exceeds the current contention window size, 814 is performed.

At 814, the count of the first counter and the count of the second counter are updated based on the second status. At 816, the count of the second counter is compared with a second threshold value. If the count of the second counter exceeds the second threshold value then 818 is performed. If the count of the second counter is lower than the second threshold value then 804 is performed and a subsequent packet of one or more packets is transmitted. At 818, a symbol corresponding to an OFF period of the interference signal is generated. Transmission of the one or more packets results in generation of a sequence of symbols. At 820, a sequence comprising a pre-defined number of symbols is compared with a pre-defined pattern for occurrence of a match. If the sequence matches the pre-defined pattern, then 822 is performed. At the 822, sensing of wireless spectrum is triggered. If the sequence does not match the pre-defined pattern then 804 onwards is performed for a new packet or in the case of first status for a retransmitted packet. The method ends at 824. At 824, a MAC layer in the wireless device adapts the transmission of the packets to the interference detected by sensing the wireless spectrum.

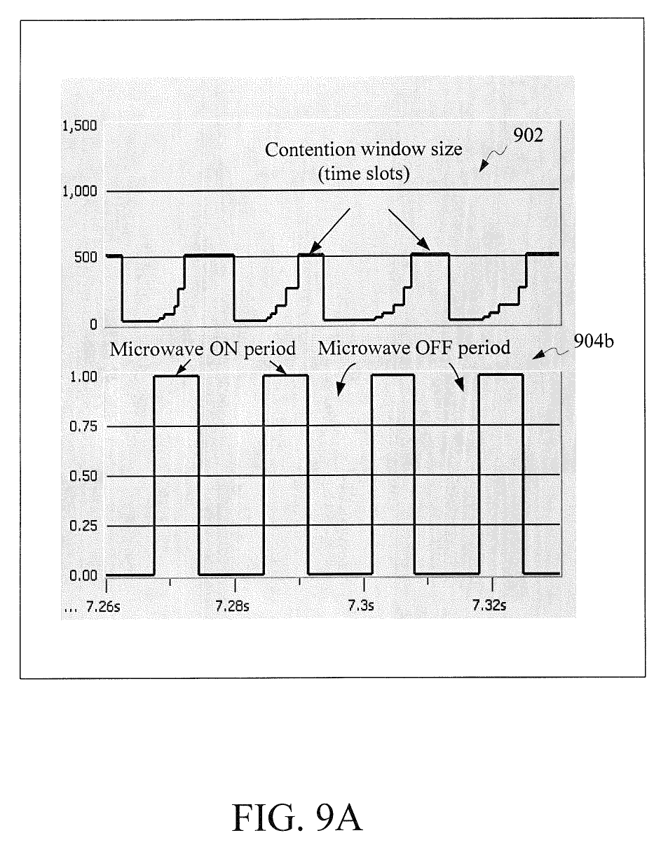

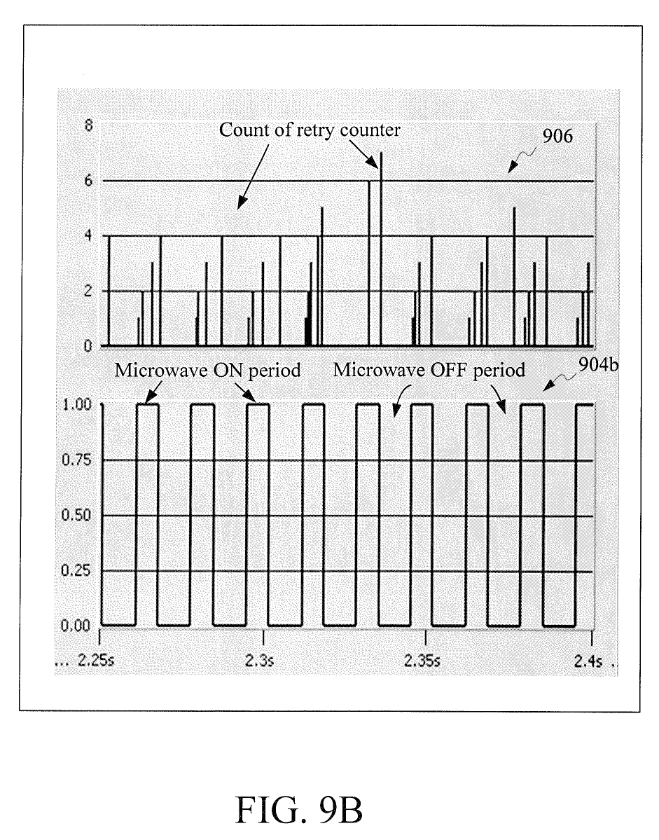

As can be seen from the description for FIG. 7 and FIG. 8, the count of the retry counter and the size of contention window may be used to indicate the presence of interference in wireless medium. The change in the contention window size and retry counter with respect to an interference signal is depicted in FIGS. 9A and 9B.

FIGS. 9A and 9B illustrate change in the contention window size and retry counter with respect to microwave oven signal variations respectively, in accordance with an embodiment of the present disclosure. FIG. 9A illustrates change in the contention window size with respect to a microwave oven signal. A plot 902 traces the change in the contention window size (measured on a time scale) for transmission of a packet in the presence of an interfering microwave oven signal (depicted by a plot 904a). The microwave signal follows an ON/OFF pattern, the ON period of microwave signal depicted by a pulse and the OFF period depicted by absence of pulse in plot 904b. It may be observed that plot 902 and the plot 904a follow a similar pattern.

FIG. 9B illustrates a change in the count of a retry counter with respect to a microwave signal. The plot 906 traces the number of times a packet is retransmitted (shown as Y-axis in the plot 906). The plot 906 follows a similar pattern as the plot 904b depicting the microwave signal. The plot 904b differs from plot 904a only in its depiction as the microwave signal 904b is plotted on a different time scale. As can be seen, the plot 902 and the plot 906 follow a periodic pattern signifying an ON/OFF pattern of the microwave signal. The ON/OFF pattern of the microwave signal causing the periodic pattern in the change in the size of contention window and the count of the retransmission counter may be used to trigger sensing of the wireless spectrum as explained in conjunction with FIG. 7 and FIG. 8. Further, the periodicity of the change in contention window size and the retry counter may be used for coarse detection of the microwave signal detection with no requirement on hardware or silicon support to perform sensing of the wireless spectrum.

In accordance with an embodiment of the present disclosure, the wireless device, such as wireless device 402a, may perform coarse detection of an interference signal, such as a microwave signal, without triggering sensing of wireless spectrum. The wireless device in such a case transmits a packet of the one or more packets and checks the status of transmission of the packet for one of a first status and a second status. The first status corresponds to retransmission of the packet and the second status corresponds to successful transmission of the packet. A count of a first counter and a count of a second counter are then updated based on the status of transmission of the packet. The count of the first counter is compared with a first threshold value and the count of the second counter is compared with a second threshold value to generate a symbol. A sequence of symbols formed by the transmission of the one or more packets is compared with a pre-defined pattern for occurrence of a match. The occurrence of a match indicates the presence of a periodic microwave signal to the wireless device. The wireless device thus coarsely detects the presence of a microwave signal and performs MAC adaptation to adapt to the interference from the microwave signal. The coarse detection of the microwave signal is especially useful for wireless devices without spectrum sensing hardware or silicon support.

The method described in conjunction with FIG. 6 may lead to significant power saving as the wireless device, such as wireless device 402a, may activate spectrum sensing hardware only when triggered. The method may further be used in digital home environments and enterprise environments prone to interference by microwave signals such as a microwave oven signal. Further, the method may be used to coarsely detect the presence of a microwave signal, thereby precluding the need to include expensive spectrum sensing hardware or silicon support.

As described above, the embodiments of the disclosure may be embodied in the form of computer-implemented processes and apparatuses for triggering a wireless device to perform sensing of wireless spectrum for detecting interference in a wireless medium. Embodiments of the disclosure may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the disclosure. The present disclosure may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the disclosure. When implemented on a general-purpose microprocessor, the computer program code segments configure the microprocessor to create specific logic circuits.

The foregoing descriptions of specific embodiments of the present disclosure have been presented for purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A method for triggering a wireless device to perform sensing of wireless spectrum for detecting interference in a wireless medium, the method comprising:
transmitting a packet of one or more packets;
checking status of transmission of the packet, wherein the status of transmission of the packet is one of a first status and a second status, and wherein the first status corresponds to retransmission of the packet and the second status corresponds to successful transmission of the packet;
updating a first counter and a second counter based on the status of transmission of the packet, wherein count of the first counter and count of the second counter is updated based on the status of transmission of the packet;
generating a symbol by comparing the count of the first counter with a first threshold value and the count of the second counter with a second threshold value;
comparing a sequence formed by symbols corresponding to transmission of the one or more packets with a pre-defined pattern,
wherein occurrence of a match between the sequence and the pre-defined pattern triggers the wireless device to perform sensing of the wireless spectrum for detecting interference in the wireless medium.

2. The method according to claim 1, wherein the wireless device is an 802.11 compliant device.

3. The method according to claim 1, wherein the interference is a microwave oven signal interference.

4. The method according to claim 1, wherein checking the status of transmission of the packet comprises checking count of a retry counter.

5. The method according to claim 4, wherein a non-zero value of the count of the retry counter corresponds to the first status.

6. The method according to claim 4, wherein a zero value of the count of the retry counter corresponds to the second status.

7. The method according to claim 1, wherein checking the status of transmission of the packet comprises comparing current contention window size for transmission of the packet with a pre-defined minimum contention window size.

8. The method according to claim 7, wherein the current contention window size exceeding the pre-defined minimum contention window size corresponds to the first status.

9. The method according to claim 7, wherein the pre-defined minimum contention window size exceeding the current contention window size corresponds to the second status.

10. The method according to claim 1, wherein updating the first counter and the second counter comprises incrementing the count of the first counter and setting the count of the second counter to zero when the status of the transmission of the packet is the first status.

11. The method according to claim 1, wherein updating the first counter and the second counter comprises incrementing the count of the second counter and setting the count of the first counter to zero when the status of the transmission of the packet is the second status.

12. The method according to claim 1, wherein the symbol corresponding to an ON period of an interference signal is generated when the count of the first counter exceeds the first threshold value.

13. The method according to claim 1, wherein the symbol corresponding to an OFF period of an interference signal is generated when the count of the second counter exceeds the second threshold value.

14. The method according to claim 1, wherein the sequence comprising a pre-defined number of consecutive symbols is compared with the pre-defined pattern for occurrence of the match.

15. The method according to claim 1, wherein the pre-defined pattern comprises a series of symbols corresponding to three ON/OFF periods of an interference signal.
